(19) United States
(12) Patent Application Publication
(10) Pub. No.: US 2005/0000198 A1
(43) Pub. Date: Jan. 6, 2005

(54) Fuel filter

(75) Inventors: Guenter Jokschas, Murrhart (DE); Jochen Reyinger, Stuttgart (DE)

Correspondence Address: CROWELL & MORING LLP;INTELLECTUAL PROPERTY GROUP, P.O. BOX 14300, WASHINGTON, DC, 20044-4300, US

(73) Assignee: Mann + Hummel GmbH, Ludwigsburg (DE)

(21) Appl. No.: 10/787,246

(22) Filed: Feb. 27, 2004

(30) Foreign Application Priority Data
Feb. 27, 2003 (DE) 103 08 427.4

(51) Int. Cl. B01D 46/00

(52) U.S. Cl. 55/423; 55/425

(57) ABSTRACT

A fuel filter (1) having a housing (2) which has an inlet (5) on a unfiltered side (13) and an outlet (6) on a clean side (14). At least one filter element (7) is situated in the housing (2) in the flow path between the unfiltered side (13) and the clean side (14). To ensure the functioning of the filter and at the same time simplify the removal of collected water, a devices for separating and draining water are provided, respectively, on the unfiltered side (13) and on the clean side (14).

### BACKGROUND OF THE INVENTION

This invention relates to a filter, and particularly to a fuel filter, comprising a housing with at least one filter element arranged therein so as to separate an unfiltered side from a clean side, and having an inlet opening into the unfiltered side and an outlet opening from the clean side, with the at least one filter element situated in a flow path between the inlet and the outlet.

German Patent DE 42 39 099 C2 discloses a fuel filter having a housing in which a filter element is situated. A water collecting chamber is provided on the clean side of the filter element. A water drain plug for draining out the collected water protrudes into the water collecting chamber.

When using certain filter materials, water may collect on both the unfiltered side of the filter element as well as on the clean side. The collected water may seriously impair the functioning of the filter. With known filters, it is not possible to drain water from the unfiltered side as well as from the clean side without dismantling the filter.

### SUMMARY OF THE INVENTION

It is an object of the present invention to provide an improved fuel filter from which any accumulated water can be discharged.

Another object of the invention is to provide a fuel filter which will allow the simple separation and complete draining of any water that collects in the filter housing.

These and other objects are achieved in accordance with the present invention by providing a fuel filter comprising a housing with at least one filter element arranged therein so as to separate an unfiltered side from a clean side; said housing having an inlet opening into the unfiltered side and an outlet opening from the clean side, said at least one filter element being situated in the housing in a flow path between the unfiltered side and the clean side, wherein first and second devices for separating and draining of water are provided, respectively, on the unfiltered side and on the clean side.

Water can be drained out completely from both the unfiltered side and the clean side due to the fact that a device for separation and drainage of water is provided on both the unfiltered side and the clean side. This device makes is possible to drain off the water without having to dismantle the filter.

Each device advantageously has a collecting chamber comprising a closable outlet opening. The outlet opening is advantageously sealed by a gasket. A simple design is obtained when the seal is provided by a packing ring held by a water drain plug between two contact surfaces. The outlet opening is formed in particular on a water drain plug.

A simple design of the fuel filter is obtained when the water drain plug has a first channel arranged radially outside of the central axis of the water drain plug, opening into a first collecting chamber and a second channel situated coaxially with the central axis of the drain plug and opening into a second collecting chamber. The two devices, one on the unfiltered side and one on the clean side, are thus formed on a common water drain plug. The two devices can be actuated together, so this makes it simple to drain water from the unfiltered side and from the clean side at the same time. The second channel is advantageously closed by a gasket which is attached to the housing. When the water drain plug is unscrewed, the gasket remains stationary while the channel situated in the water drain plug is unscrewed. This makes it possible to open the channel by a simple method. The gasket is advantageously designed as a sealing ring held on a pin or plug, whereby the pin protrudes into the channel. However it may also be advantageous for the gasket to be attached to a plunger or push rod and to be pressed against an opening in the end of the channel by a spring. Manufacturing tolerances can be compensated by the spring, so that a good seal of the channel is always assured. The spring path is limited so that the channel is opened when the water drain plug is moved beyond a certain distance along its path of movement.

An outlet opening is advantageously connected to a pipe into which a water drain plug protrudes. In this case, the outlet opening is at the bottom of a pot or cylindrical vessel, with the collecting chamber being formed in the pot. The outlet opening is advantageously sealed by a flat gasket, which is held in a sealing seat by a spring. Providing the flat gasket at the bottom of the pot ensures that all the collected water will be completely drained out. At the same time, secure sealing during operation is assured due to the spring. This device advantageously has an actuator which acts against the spring force. Simple operability of the device is obtained when the actuator is designed as a push rod. Pushing on the push rod results in the flat gasket being loosened from the sealing seat, thus opening the outlet opening.

It may be advantageous for the fuel filter to have a plurality of filter elements which are arranged in succession along the flow path. To ensure functioning of such a filter during operation, a device for separating and draining off water is provided on the unfiltered side and on the clean side of at least two filter elements, in particular all filter elements. This prevents water from collecting in all areas of the housing of the fuel filter.

### BRIEF DESCRIPTION OF THE DRAWINGS

The invention will be described in further detail hereinafter with reference to illustrative preferred embodiments shown in the accompany drawing figures, in which:

FIG. 1 and FIG. 2 show schematic longitudinal sections through fuel filters constructed according to the invention;

FIG. 3 shows an enlarged detail of a longitudinal section of another device for separating and draining off water according to the invention;

FIG. 4 shows a detail of a schematic diagram of a fuel filter in a longitudinal section; and

FIG. 5 shows a schematic diagram of devices for separating and draining off water from a fuel filter in a longitudinal section.

### DETAILED DESCRIPTION OF PREFERRED EMBODIMENTS

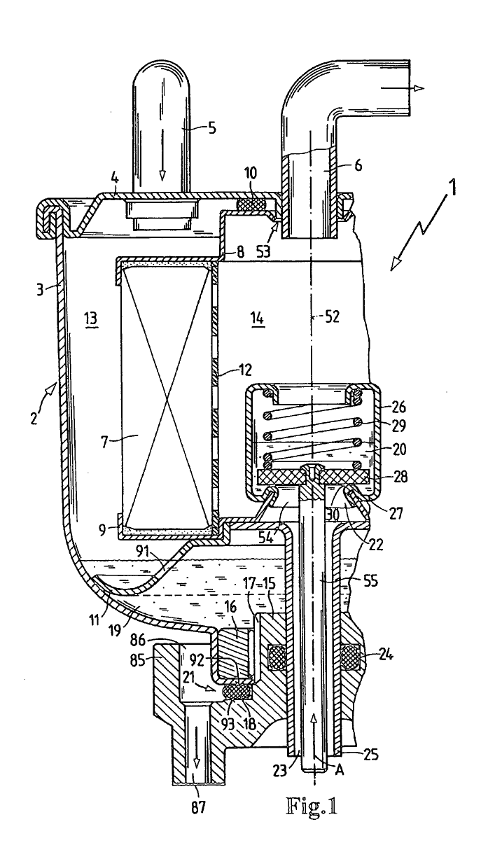

FIG. 1 shows a fuel filter 1 having a housing 2. The housing 2 comprises a housing pot 3 which is sealed with a cover 4. The fuel filter 1 has a symmetrical design, but only one side of the fuel filter 1 is shown in FIG. 1. A filter element 7 separating an unfiltered side 13 from a clean side 14 is provided in the housing 2. An inlet 5 in the cover 4 opens on the unfiltered side 13 radially outside of the longitudinal central axis 52 of the fuel filter 1. The outlet 6, which opens from the clean side 14, is secured in the cover so that it is coaxial with the longitudinal central axis 52. The end face of filter element 7 which faces the cover 4 is connected to a mounting member 8. The opposite end of filter element 7 is connected to a mounting member 9 and is sealed to make it fluid tight. The filter element 7 has a cylindrical construction and is made of filter paper pleated in lamellar folds. A central tube 12 is situated in the central channel of the filter element 7. The mounting member 8 adjacent the cover is supported on the cover 4 by a gasket 10. The mounting member 9 is held against the housing pot 3 by a guide 11. The guide 11 is constructed in one piece and is rotationally symmetrical with the longitudinal central axis 52 and has openings 91. However, guide 11 may also be formed by a plurality of individual struts, which are in a rotationally symmetrical configuration about the longitudinal central axis 52 in particular, with intervening spaces formed between them. The position of the filter element 7 in the housing 2 is thus fixed by the two mounting members 8 and 9. The mounting member 8 has a central opening 53 through which the outlet 6 extends. An enclosure 26 is secured on the central opening 54 of the mounting member 9.

The enclosure 26 situated on the clean side 14 has an outlet opening 22 which opens into a channel 23. The channel 23 is designed in a pipe 25 which is connected in a sealed manner to the mounting member 9. The pipe 25 extends on the outside of the housing 2. A collecting chamber 20 is formed in the interior of the enclosure 26. The outlet opening 22 is sealed by a flat gasket 28. Arranged inside the enclosure 26 is a spring 29 which presses the flat gasket 28 against a sealing seat 30 provided in the bottom 27 and thus seals the collecting chamber 20 from the outside of the housing 2. The flat gasket 28 is connected to a push rod 55 which extends through the pipe 25 to the outside of the housing 2. The push rod 55 passes through the flat gasket 28 and clamps it between radial surfaces. By pressing on the push rod 55, the flat gasket 28 may be lifted up from the sealing seat 30 so that water collected in the collecting chamber 20 of the enclosure 26 passes through the channel 23 to the outside of the fuel filter 1.

The tube 25 passes through a water drain plug 15 which is situated opposite the cover 4 in the bottom of the housing pot 3. The water drain plug 15 has a gasket 24 which is constructed as an O-ring and extends toward the tube 25 and seals the intervening space between the water drain plug 15 and the tube 25 on the outside of the housing. The water drain plug 15 is screwed into a threaded insert 16 that is fixedly connected to the housing pot 3. In the interior of the housing 2, there is a collecting chamber 19, which is situated on the unfiltered side 13 of the filter element 7 and which is located in the area of the water drain plug 15. The water drain plug 15 has a channel 17 which passes through the water drain plug 15 in the area of the thread and thus establishes a fluid connection between the collecting chamber 19 and the exterior of the housing. At the base of the thread of the water drain plug 15, there is a gasket 18 which seals the channel 17. When water drain plug 15 is tightened, a contact surface 93 on the water drain plug presses the gasket 18 against a contact surface 92 formed on the housing 2. The gasket 18 thus seals the outlet opening 21 which constitutes the connection between the channel 17 and the exterior of the housing. A collecting pan 86 is formed in the drain plug 15 radially outside of the gasket 18. It is bounded radially on the outside by a raised edge 85. This edge 85 simultaneously constitutes the gripping surface for manually opening the water drain plug 15. From the collecting pan 86, an outlet 87 leads to the side of the water drain plug 15 which faces away from the housing 2.

During operation of the fuel filter 1, water collects in the collecting chamber 19 on the unfiltered side 13 as well as in the collecting chamber 20 on the clean side 14. To drain the collected water from the unfiltered side 13, the water drain plug 15 is released. The downward movement of the drain plug 15 relative to the housing 2 results in the gasket 18 no longer being held securely between the contact surfaces 92 and 93, so that water can flow out of the collecting chamber 19 through the channel 17 and the outlet opening 21 into the collecting pan 86 and leave the water drain plug 15 through the outlet 87. After draining off the water, the water drain plug 15 is tightened again so that the gasket 18 is again clamped between contact surfaces 92 and 93, and there is a fluid seal between the interior of the housing and the outside of the housing.

In order to drain out water collected in the collecting chamber 20, the push rod 55 is pushed by the operator in the direction of arrow A into the housing 2. This results in the flat gasket 28 being lifted from the sealing seat 30 and thus water flowing through the channel 23 to the outside of the housing. When the push rod 55 is released, the flat gasket 28 is pressed again by the spring 29 against the sealing seat 30, so that the clean side 14 is sealingly separated in a fluid-tight manner from the outside of the housing.

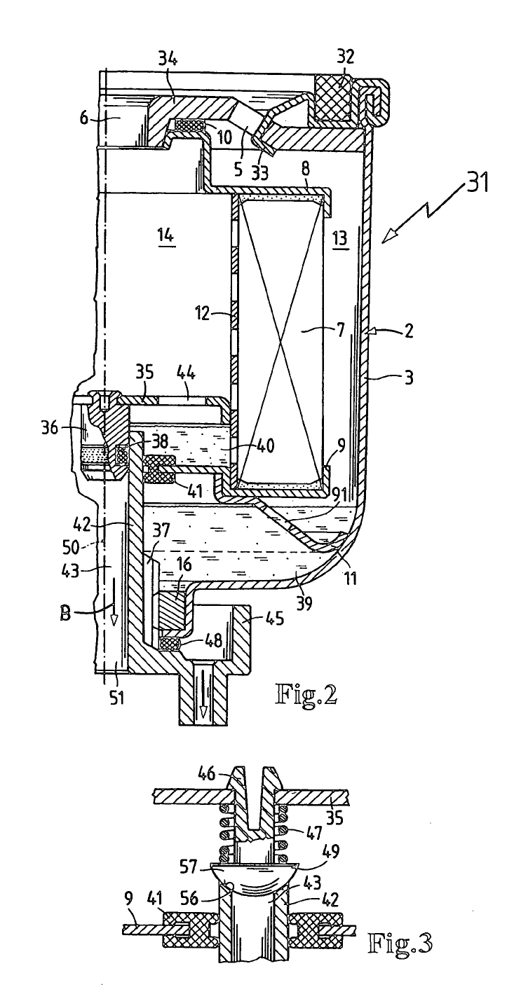

FIG. 2 shows a fuel filter 31 having a design which corresponds substantially to the fuel filter 1 shown in FIG. 1. The same reference numerals as in FIG. 1 denote corresponding parts in FIG. 2. The housing 2 of the fuel filter 31 is formed from a housing pot 3 which is closed by a cover 34. The cover 34 is held by a clamp 33 on the housing pot 3. The clamp 33 at the same time serves to accommodate a gasket 32 which extends outward away from the cover 34. A first collecting chamber 39 is formed on the unfiltered side 13 of the filter element 7 and is closed relative to the outside of the housing by a water drain plug 45. The water drain plug 45 has a channel 37 in the area of its thread with which it is screwed into a threaded insert 16. The channel 37 is sealed by a gasket 48 relative to the outside of the housing in a manner corresponding to the channel 17 in FIG. 1.

A tubular section 42 extending into the interior of the central tube 12 is situated radially inside the thread of the water drain plug 45. The mounting member 9 of the filter element 7 is sealed relative to the tubular section 42 by a gasket 41. The mounting member 9, tubular section 42 and central tube 12 together form an annular trough, with the second collecting chamber 40 being created therein. A channel 43 is formed in the interior of the tubular section 42 and extends coaxially around the central axis 50 of the water drain plug 45. The channel 43 opens through an outlet opening 51 on the outside of the housing. A pin 36, which extends into the channel 43 and has a gasket 38 for sealing the channel 43 relative to the collecting chamber 40, is situated on the side of the tubular section 42 that protrudes into the interior of the housing. Pin 36 is supported on a mounting member 35 which is constructed approximately in the form of a disk and is supported in turn on the central tube 12. To allow water to reach the collecting chamber 40, mounting member 35 is provided with openings 44.

In order to drain accumulated water from the housing 2, the water drain plug 45 is turned so that the plug moves in the direction of arrow B relative to the housing 2. This causes the gasket 48 to no longer provide a seal, so water can then pass from the collecting chamber 39 through the channel 37 to the outside of the housing. Through this movement of the water drain plug 45, the pin 36, which is fixedly connected by the mounting member 35 to the central tube 12 and in this way is secured in the housing 2, is withdrawn from the tubular section 42, so there is no longer a seal. Water collected in the collecting chamber 40 can then flow through the channel 43 to the outside of the housing.

FIG. 3 shows an alternative embodiment of a device for collecting and draining off water, which may be used instead of the pin 36. The same reference numerals here denote the same components as in FIG. 2. In this embodiment, a plunger 46, having a gasket 49 affixed to it, is supported in the mounting member 35. The side of gasket 49 facing the tubular section 42 is configured in the form of a spherical section, while the side of gasket 49 facing the plunger 46 is flat. The gasket 49 is in contact with the end face 57 of the tubular section 42 and is pressed against the end opening 56 of the channel 43. The gasket 49 is pressed by a spring 47 against the end face 57 so as to assure a reliable seal. The spring path of the spring 47 is limited so that tolerances can be compensated, but at the same time the opening of the water drain device is assured.

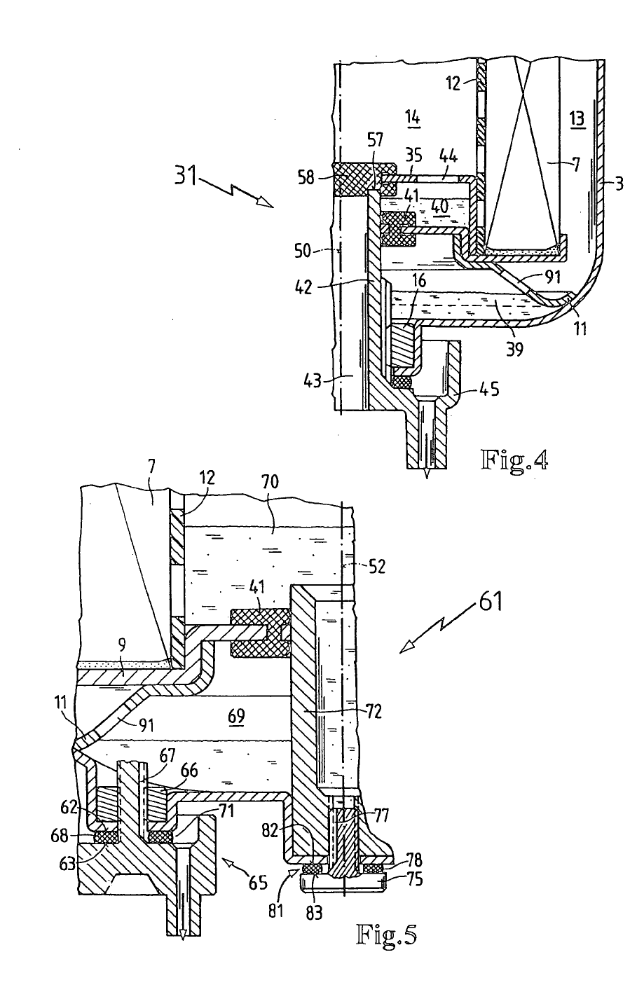

In the illustrative embodiment of the fuel filter 31 according to FIG. 4, the tubular section 42, in which the channel 43 is constructed, is sealed by a flat gasket 58 which is in contact with the end face 57 of the tubular section 42. In this embodiment, the flat gasket 57 is supported in the mounting member 35. When the water drain plug 45 is opened, the tubular section 42 moves away from the flat gasket 58, so a seal no longer exists, and water can flow out of the collecting chamber 40 through the channel 43 to the outside.

FIG. 5 shows a cross-sectional detail view of a fuel filter 61. A first collecting chamber 69 where a water drain plug 65 is situated is provided on the unfiltered side of the fuel filter 61. The water drain plug 65 is situated radially outside of the longitudinal central axis 52 of the fuel filter 61. The water drain plug 65 is screwed into a threaded insert 66 and has a channel 67 which is sealed by a flat gasket 68. The flat gasket 68 is held by the water;drain plug 65 between the contact surfaces 62 and 63 formed on the housing 2 and on the water drain plug 65, respectively. When the water drain plug 65 is loosened, water can flow out of the collecting chamber 69 through the channel 67 and the outlet opening 71 to the outside of the housing 2.

A tube 72 on the clean side of the filter extends coaxially with the longitudinal central axis 52 of the fuel filter 61. The tube 72 opens into a second collecting chamber 70 which is sealed relative to the first collecting chamber 69 by a gasket 41 which extends between the mounting member 9 and the tube 72. A water drain plug 75 is screwed on to the end of the tube 72 which extends outside of the housing. The water drain plug 75 has a channel 77 which is sealed by a gasket 78 on the outside of the housing. The gasket 78 is in contact with a contact surface 82 formed on the housing 2 and a contact surface 83 formed on the water drain plug 75. When the drain plug 75 is opened, a gap is formed between the gasket 78 and the contact surfaces, allowing water to flow out through the channel 77 and the outlet opening 81 to the outside of the housing.

It may be advantageous for a device for draining out water to be electromagnetically actuated. If there are several filter stages, i.e., several filter elements arranged successively in the direction of flow in a housing 2, then advantageously a device for draining water is provided on each of at least two filter elements, in particular in each filter element on the unfiltered side as well as on the clean side.

The foregoing description and examples have been set forth merely to illustrate the invention and are not intended to be limiting. Since modifications of the described embodiments incorporating the spirit and substance of the invention may occur to persons skilled in the art, the invention should be construed broadly to include all variations within the scope of the appended claims and equivalents thereof.

1. A fuel filter comprising a housing with at least one filter element arranged therein so as to separate an unfiltered side from a clean side; said housing having an inlet opening into the unfiltered side and an outlet opening from the clean side, said at least one filter element being situated in the housing in a flow path between the unfiltered side and the clean side, wherein first and second devices for separating and draining of water are provided, respectively, on the unfiltered side and on the clean side of the filter.

2. A fuel filter according to claim 1, wherein each separating and draining device has a collecting chamber with a sealable outlet opening.

3. A fuel filter according to claim 1, wherein the outlet opening is sealed by a gasket.

4. A fuel filter according to claim 3, wherein the gasket is a sealing ring which is held by a water drain plug between two contacting surfaces.

5. A fuel filter according to claim 2, wherein the sealable outlet opening is provided at a water drain plug.

6. A fuel filter according to claim 5, wherein the water drain plug has a first channel arranged radially outside of a central axis of the water drain plug, said first channel opening into a first collecting chamber, and a second channel arranged coaxially with the central axis of the water drain plug, said second channel opening into a second collecting chamber.

7. A fuel filter according to claim 6, wherein the second channel is sealed by a gasket connected to the housing.

8. A fuel filter according to claim 7, wherein the gasket is constructed as a sealing ring held on a pin, and the pin extends into said second channel.

9. A fuel filter according to claim 7, wherein the gasket is attached to a plunger and is pressed by a spring against an end opening of said second channel.

10. A fuel filter according to claim 1, wherein an outlet opening is connected to a tube which extends through a water drain plug.

11. A fuel filter according to claim 2, wherein the outlet opening is arranged at the bottom of a pot, and the collecting chamber is formed in the pot.

12. A fuel filter according to claim 2, wherein the outlet opening is sealed by a flat gasket which is held by a spring against a sealing seat.

13. A fuel filter according to claim 12, wherein the separating and draining device has an actuator that acts against the force of said spring.

14. A fuel filter according to claim 13, wherein the actuator is constructed as a push rod.

15. A fuel filter according to claim 1, wherein the fuel filter comprises a plurality of filter elements arranged successively in a direction of flow, and wherein a device for draining out water is provided on the unfiltered side and on the clean side of at least two filter elements.
